(19) United States
(12) Patent Application Publication
(10) Pub. No.: US 2009/0027566 A1
(43) Pub. Date: Jan. 29, 2009

(54) Flexible sheet audio-video device

(76) Inventor: Kenneth Wargon, Manly (NSW) (AU)

Correspondence Address: JOHN R. BENEFIEL, 525 Lewis Street, BIRMINGHAM, MI, 48009, US

(21) Appl. No.: 12/220,797

(22) Filed: Jul. 28, 2008

Related U.S. Application Data
(60) Provisional application No. 60/952,393, filed on Jul. 27, 2007.

(51) Int. Cl. H04N 5/66

(52) U.S. Cl. 348/739; 348/E05.133

(57) ABSTRACT

An audio visual device in which a flexible sheet carries at least partially interspersed arrays of audio and video elements, the video elements able to display or sense images to act as a display and/or a camera and the audio elements able to reproduce or sense sounds to act as a speaker and/or a microphone.

### CROSS REFERENCE TO RELATED APPLICATIONS

This application claims the benefit of U.S. provisional application Ser. No. 60/952,393 filed on Jul. 27, 2007 entitled “Flexible Imaging Panels Including Arrays Of Audio And Video Input And Output Elements”.

### BACKGROUND OF THE INVENTION

There have heretofore been described miniature audio elements to perform the functions of a microphone or a speaker.

See for examples of such audio elements the following which are incorporated herein by reference.
1) “Digital Sound Reconstruction Using Arrays of CMOS-MEMS Microspeakers” published on Jun. 8-12, 2003 by IEEF, INSPEC ACCESSION No. 7936579 By Diamond, B. M., Neumann, J. J., Gabriel, K. J. This paper also appears in: Micro Electro Mechanical Systems, 2002. The Fifteenth IEEE International Conference on Page(s): 292-295
2) “Method And Apparatus For Reconstruction Of Soundwaves From Digital Signals”, U.S. Pat. No. 7,089,069 B2, Aug. 8, 2006
3) “Ultrathin Form Factor MEMS Microphones And Microspeakers”, U.S. Pat. No. 6,936,524 B2
4) “Flexible MEMS Transducer Manufacturing Method”, U.S. Pat. No. 7,151,057 B2, Dec. 19, 2006
5) “Flexible MEMS Transducer And Manufacturing Method Thereof, And Flexible MEMS Wireless Microphone”, U.S. Pat. No. 6,967,362 B2, Nov. 22, 2005
6) “MEMS Digital-To-Acoustic Transducer With Error Cancellation”, WO 2001/020948, Publication Date Mar. 22, 2001
7) “MEMS Digital-To-Acoustic Transducer With Error Cancellation”, U.S. Pat. No. 6,829,131, Dec. 7, 2004
8) “Optical-Interference Microphone”, U.S. Pat. No. 6,483,619, Nov. 19, 2002

In U.S. Pat. No. 6,936,524 B2, MEMS (Micro Electro Mechanical Systems) devices manufactured using CMOS technology are described as being useable as either miniature speakers or miniature microphone elements. Miniature audio elements are also based on other technologies such as optical-interference and piezoelectric.

Sound reconstruction by the use of arrays of miniature audio elements have been described in the above referenced U.S. Pat. No. 7,089,069 B2 entitled “Method And Apparatus For Reconstruction Of Soundwaves From Digital Signals”, and the “Digital Sound Reconstruction Using Arrays of CMOS-MEMS Microspeakers” article. As is known by those skilled in the art, advantages of utilizing arrays of miniature speaker elements include true digital reconstruction of sound and the ability to implement acoustic beam control technology; while advantages of the use of miniature microphone arrays include the ability to use noise reduction and sound quality enhancement technologies.

The miniaturized configuration of these audio devices offers additional advantages over traditional macro-sized devices including the ability to utilize micromachining manufacturing techniques, improved performance, minimize component space requirements, unobtrusive audio element placement, minimized weight, thin profile, low cost processing, mass production with uniform tolerances enabling predictable performance characteristics, etc.

There has also been developed small video imaging elements, such as LCD (liquid crystal display), and LED (light emitting diodes), which are now in widespread use in electronic displays for televisions, cameras, cell phones, computer monitors, etc. These elements are arranged in an array in a display panel and activated in such a way as to jointly produce an image made up of pixels, each comprised of an individual video imaging element. There also has been in widespread use light sensors such as CMOS (complimentary metal oxide semiconductor) light sensors and CCD'S (charged coupled devices) for image capture purposes such as in digital cameras.

U.S. Pat. No. 7,034,866 B1 entitled “Combined Display-Camera For An Image Processing System”, dated Apr. 25, 2006, and Patent application WO 2004/107301 entitled “Photoelectric Element And Terminal Equipment Including A Photoelectric Element”, International Publication Date Dec. 9, 2004, and U.S. Patent application US2006/0007222A1 entitled “Integrated Sensing Display”, dated Jan. 12, 2006 are incorporated herein by reference, and describe an integrated sensing display in which an array of display elements is located within a display area, and an array of image sensing elements is also located within the same display area. Thus, both a display and a camera are provided in the same space. Certain advantages accrue from such a combination as described in these referenced publications.

The present inventor has proposed further enhancements in U.S. patent publication no. 2007/0268209A1 dated Nov. 22, 2007, incorporated herein by reference, in which an audio-video device is comprised of at least partially integrated arrays of miniature audio and video elements carried by a panel. These audio and video element arrays are described as including input and output elements, i.e., broadcasting or displaying audio and video signals respectively or sensing sounds and images.

The audio input and output elements may take the form of miniature speakers and miniature microphones manufactured utilizing CMOS-MEMS or other technologies. The video imaging input and output elements may take the form of miniature display elements such as LCD's or LED's, and image sensing elements such as CCD's or CMOS photosensitive detectors, although other video imaging technologies may be employed.

It has also been proposed to provide flexible sheets capable of displaying images. See the following U.S. patents incorporated herein by reference describing video elements incorporated into flexible sheets:
“Flexible Electronic Viewing Device”, U.S. Pat. No. 6,680,724 B2, Jan. 20, 2004
“Display Device”, U.S. Pat. No. 6,819,045 B2, Nov. 16, 2004
“Flexible Flat Color Display”, U.S. Pat. No. 6,490,402 B1, Dec. 3, 2002

Such flexible displays have utility in a number of possible applications. It is an object of the present invention to provide an enhancement to such flexible displays to increase their capabilities.

### SUMMARY OF THE INVENTION

The above object as well as other objects which will be understood upon a reading of the following specification and claims are achieved by an audio-video device having arrays of small video and small audio elements at least partially interspersed together carried by a flexible sheet. Various combinations of audio sensing elements such as CMOS-MEMS microphones and/or audio reproducing elements such as CMOS-MEMS speakers are combined with video image sensing elements such as CMOS image sensors, CCD image sensors and/or video image displaying elements, such as LCD, LED elements, to provide both audio and video functions in a single flexible audio-video device. The video elements may form a video image or generate signals corresponding to an image. The audio elements are typically on the same order of size or smaller than the video imaging elements so as to not interfere substantially with an image displayed or acquired. The arrays of audio and video elements carried by the flexible sheet audio-video device according to the present invention may be completely interspersed or partially segregated, and be distributed homogeneously or non-homogeneously. The flexible/bendable nature of the flexible sheet audio-video device enables it to function in a planar, non-planar, contoured or variable shaped configuration.

### DESCRIPTION OF THE DRAWINGS

FIG. 1A is a cross sectional side view of a flexible sheet audio-video device according to the invention in a planar configuration having arrays of both audio signal input elements and audio signal output elements combined with arrays of both video imaging signal input elements and video imaging signal output elements and the silicon islands containing said elements.

FIG. 1B is a cross sectional side view of the flexible sheet audio-video device in FIG. 1A in a non-planar flexed or bent configuration.

FIG. 2A is a cross sectional side view of a flexible sheet audio-video device according to the invention in a planar configuration having arrays of both audio signal input elements and audio signal output elements combined with arrays of both video imaging signal input elements and video imaging signal output elements.

FIG. 2B is a cross sectional side view of the flexible sheet audio-video device in FIG. 2A in a non-planar flexed or bent configuration.

FIG. 3 is a diagrammatic planar representation of a flexible sheet audio-video device according to the invention including arrays of both audio and video elements.

FIG. 4 is a diagrammatic planar representation of a flexible sheet audio-video device according to the invention having arrays of both audio signal input speaker elements and audio signal output microphone elements combined with arrays of both video imaging signal input display elements and video imaging signal output image capture elements together with a block diagram of associated components.

FIG. 5A is a front view of a conferencing monitor including a flexible sheet audio-video device according to the invention having arrays of both video imaging signal input display elements and video imaging signal output camera elements also including arrays of both audio signal input speaker elements and audio signal output microphone elements.

FIG. 5B is a front view of the conferencing monitor shown in FIG. 5A with an alternate distribution of audio signal input speaker array elements.

FIG. 5C is a frontal view of a cylindrical columnar kiosk and a viewable exposed section of the flexible sheet audio-video device forming the conference monitor of FIG. 5A wrapped around the circumference of said kiosk along with a displayed image on said flexible sheet audio-video device.

FIG. 5D is a plan view of a cell phone with a flexible sheet audio-video device according to the invention having arrays of both video and audio elements.

FIG. 6 is a diagrammatic planar representation of a flexible sheet audio-video device according to the invention having arrays of both audio signal output elements and video imaging signal output elements and a block diagram of associated components.

FIG. 7A is a diagrammatic planar representation of a flexible sheet audio-video device according to the invention having arrays of both audio signal input elements and video imaging signal input elements together with a block diagram of associated components.

FIG. 7B is a front view of an article of clothing supporting a flexible sheet audio-video device according to the invention having arrays of both audio signal input speaker elements and video signal input display elements.

FIG. 8A is a front view of a non-planar wrap-around automobile instrument panel covered by a flexible sheet audio-video device according to the invention having arrays of both video imaging signal input display elements and audio signal input speaker elements.

FIG. 8B is a front view of the non-planar wrap-around automobile instrument panel covered with a flexible sheet audio visual device as shown in FIG. 8A highlighting specific audio-visual portions thereof.

FIG. 8C is a front view of the non-planar wrap-around automobile instrument panel covered with a flexible sheet audio-video device as shown in FIG. 8B highlighting specific audio-visual portions thereof.

FIG. 9 is a diagrammatic planar representation of a flexible sheet audio-video device according to the invention having arrays of both audio signal input elements and video imaging signal output elements with a block diagram of the associated components.

FIG. 10 is a diagrammatic planar representation of a flexible sheet audio-video device according to the invention having arrays of both audio signal output elements and video imaging signal input elements with a block diagram of the associated components.

FIG. 11 is a diagrammatic planar representation of a flexible sheet audio-video device according to the invention having arrays of audio signal input elements, audio signal output elements, and video imaging signal output elements together with a block diagram of associated components.

FIG. 12 is a diagrammatic planar representation of a flexible sheet audio-video device according to the invention having arrays of both audio signal input elements and audio signal output elements combined with arrays of video imaging signal input elements together with a block diagram of associated components.

FIG. 13 is a diagrammatic planar representation of a flexible sheet audio-video device according to the invention having arrays of audio signal output elements combined with arrays of both video imaging signal input elements and video imaging signal output elements and a block diagram representation of associated components.

FIG. 14 is a diagrammatic planar representation of a flexible sheet audio-video device according to the invention having arrays of audio signal input elements combined with arrays of both video imaging signal input elements and video imaging signal output elements together with a block diagram representation of associated components.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

The following referenced patents and articles which are herein incorporated by reference describe examples of technologies which may be employed in the fabrication of flexible sheet audio-video devices according to the invention although other technologies, fabrication processes, and techniques may also be utilized.
U.S. Pat. No. 6,479,890 B1 dated Nov. 12, 2002 and entitled “Semiconductor Microsystem Embedded In Flexible Foil”, by Hoc Khiem Trieu, Wilfried Mokwa, and Lutz Ewe
Article entitled “Flexible Circuit and Sensor Arrays Fabricated By Monolithic Silicon Technology” appearing in “IEEE transactions On Electron Devices, Vol. ED-32, No. 7, July 1985” by Phillip W. Barth, Sharon Lea Bernard, and James B. Angell
U.S. Pat. No. 6,071,819 dated Jun. 6, 2000 and entitled “Flexible Skin Incorporating MEMS Technology”, by Yu-Chong Tai, Fukang Jiang, Chihming Ho
U.S. Pat. No. 6,953,982 B1 dated Oct. 11, 2005 and entitled “Flexible Skin Incorporating MEMS Technology” by Yu-Chong Tai, Fukang Jiang, Chihming Ho
U.S. Pat. No. 6,762,510 B2 dated Jul. 13, 2004 and entitled “Flexible Integrated Monolithic Circuit” by Johann-Heinrich Fock et al
Internet Article by Yong Xu, Associate Professor, Wayne State University, Jun. 30, 2008, entitled “Smart Skins”, Web Address: http://www.ece.eng.wayne.edu/˜yxu/doc/researches/smart%20skin.htm
Internet Article by Yong Xu, Associate Professor, Wayne State University, Jun. 30, 2008, entitled “Intelligent Textiles”, Web Address: http://www.ece.eng.wayne.edu/˜yxu/doc/researches/Intelligent%20textiles.htm
Imaging Panels Including Arrays of Audio and Video Input and Output Elements”, U.S. Patent Application Publication No. 2007/0268209 A1, dated Nov. 22, 2007
“Flexible Electronic Viewing Device”, U.S. Pat. No. 6,680,724 B2, Jan. 20, 2004
“Display Device”, U.S. Pat. No. 6,819,045 B2, Nov. 16, 2004
“Flexible Flat Color Display”, U.S. Pat. No. 6,490,402 B1, Dec. 3, 2002

U.S. Pat. Nos. 6,071,819 and 6,953,982 and the above referenced article “smart skins” by Yong Xu describe “flexible skins” that are comprised of “silicon islands” compatible with IC and MEMS devices. Devices such as MEM's based audio sensing transducer elements (i.e. microphones) and MEM's based audio reproducing transducer elements (i.e. speakers), CMOS based image sensing elements (i.e. CMOS photo sensors), and video image displaying elements such as LCD's and LED's may comprise such silicon islands to form flexible sheet audio-video devices having audio and video element arrays.

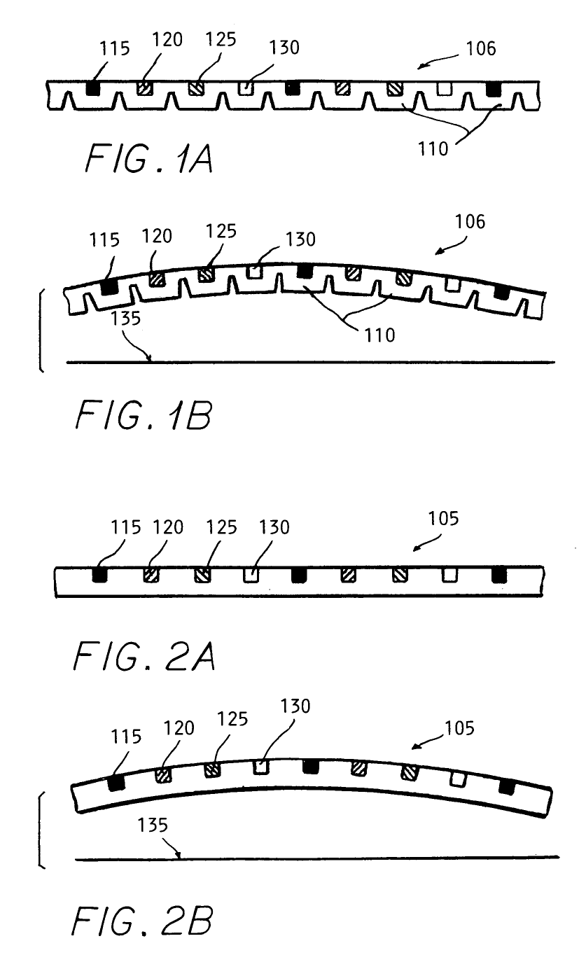

FIGS. 1A and 1B illustrate flexible sheet audio-video devices 106 which employ the above “flexible skin” technology whereby FIG. 1A shows a cross sectional side view of flexible sheet audio-video device 106 in a planar configuration, and FIG. 1B shows the same flexible sheet audio-video device 106 in a bent, flexed, or non-planar configuration. The curvature of flexible sheet audio-video device 106 in FIG. 1B is highlighted by comparison to an adjacent imaginary line 135. Each silicon island position 110 may contain an audio or video-imaging element (or combinations thereof, or constituent elements comprising same). Element 115 corresponds to an audio sensing element (i.e. MEMS-CMOS microphone), 120 corresponds to an audio reproducing element (i.e. MEMS-CMOS microspeaker), 125 corresponds to a video image sensing element (i.e. CCD, CMOS based image sensor/camera), and 130 corresponds to a video image displaying element such as a LED or LCD element. The audio and video elements and silicon islands are shown diagrammatically as being relatively large for clarity, but would typically be much smaller such as the size of pixels in computer monitor displays or smaller. The detailed connections which are apparent to one skilled in the art are not illustrated in order to simplify and improve the clarity of the drawings.

U.S. Pat. No. 6,762,510 describes flexible integrated monolithic circuits comprised of electronic circuit elements. This technology may be used to practice the present invention with elements such as MEM's based audio sensing transducer elements (i.e. microphones) and MEM's based audio reproducing transducer elements (i.e. speakers), video imaging sensor elements such as CCD's or CMOS based image sensing elements (i.e. camera), and video imaging display elements such as LCD's and LED's incorporated into a flexible sheet audio-video device including interspersed audio and video element arrays as depicted in FIGS. 2A and 2B and described below.

FIGS. 2A and 2B illustrates such flexible sheet audio-video device 105. FIG. 2A shows a cross sectional side view of flexible sheet audio-video device 105 in a planar configuration, while FIG. 2B shows the same flexible sheet audio-video device 105 in a bent, flexed, or non-planar configuration. The curvature of flexible sheet audio-video device 105 in FIG. 2B is highlighted by comparison to an adjacent imaginary line 135. Audio and video imaging elements (or combinations thereof, or constituent elements comprising same) are exemplified in the figures where 115 corresponds to an audio sensing element (i.e, microphone), 120 corresponds to an audio reproducing element (i.e., microspeaker), 125 corresponds to a video image sensing element (i.e., micro camera), and 130 corresponds to a video image display element such as a LED or LCD element. The audio and video elements are shown diagrammatically as being relatively large for clarity, but would typically be much smaller such as the size of pixels in computer monitor displays or smaller. The detailed connections which are apparent to one skilled in the art are not illustrated in order to simplify and improve the clarity of the drawings.

Provision is sometimes made by those skilled in the art to provide for an accessible air interface between the environment external to the audio transducers and said transducers to facilitate proper functioning thereof, and to provide for a transparent interface between the external environment and the video imaging elements to facilitate for clear image capture and display. Lenses (not shown) may be utilized in conjunction with the video imaging elements in order to generate acceptable images.

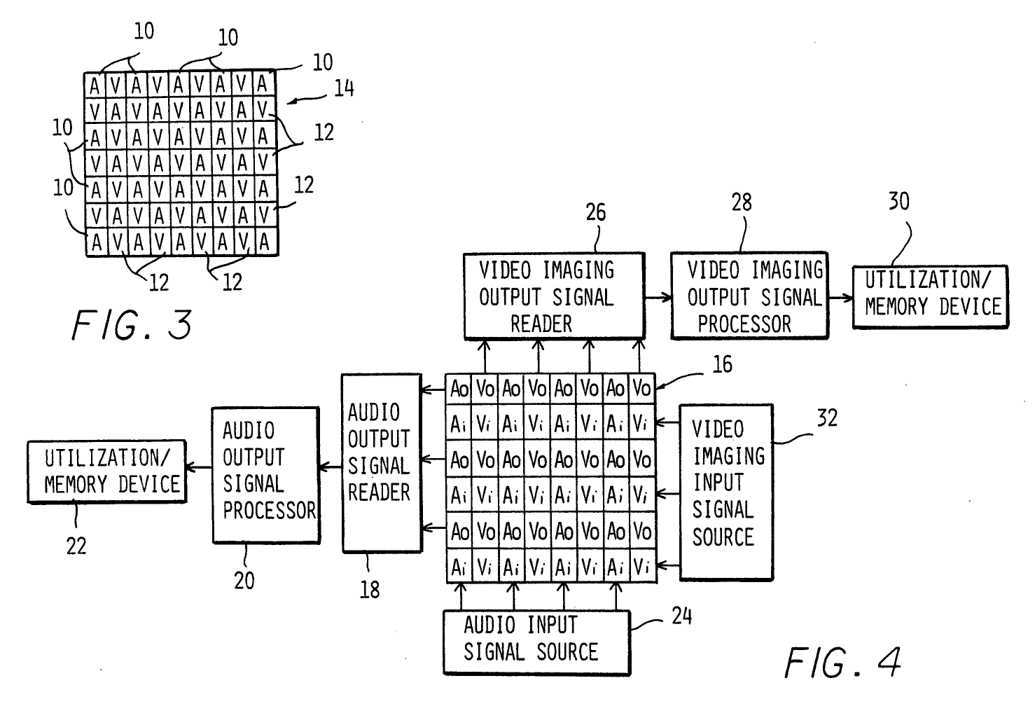

Referring to FIG. 3, according to the present invention, audio elements 10 and video elements 12 are combined in a flexible sheet audio-video device 14 to provide related functions in one device. The elements are shown diagrammatically as being relatively large for clarity, but would typically be much smaller i.e., the size of pixels in computer monitor displays or smaller.

These audio elements may comprise one or more arrays of audio signal input elements (i.e., sound reproducing elements such as CMOS-MEMS speakers) and/or audio signal output elements (i.e., sound sensing elements such as CMOS-MEMS microphones) such as described in U.S. Pat. No. 6,936,524 referred to above.

The audio signal input elements, i.e. sound reproducing elements, may comprise speaker elements receiving input signals from an audio signal source to produce sound. A stereo effect may be achieved by two or more separate audio signals transmitted to speakers in different spaced apart areas of an array of audio signal input elements in a flexible sheet audio-video device. Other effects may be achieved by sending differing signals to elements in different areas of the flexible sheet audio-video device. These signals may be generated by sources such as suitable software and/or hardware.

The video elements may comprise one or more arrays of video imaging signal input elements (i.e., image producing elements such as LCD's, LED's) collectively forming a displayed image, and/or video imaging signal output elements (i.e., light sensing elements such as CMOS light sensors, CCD's) collectively providing a camera function such as described in U.S. Pat. No. 7,034,866, published application U.S. 2006/0007222 A1, and published application WO 2004/107301 A1.

Each audio element 10, video element 12, or arrays of said elements may be comprised of groupings of constituent elements.

The video imaging elements 12 may be arranged in an array in the flexible sheet audio-video device 14 comprised of vertical and horizontal crossing rows as shown in FIG. 3, or various other patterns with various differing proportions of other arrays of audio elements 10 and/or video elements 12; or, with equal numbers of each as required for a particular application. The distribution of each type of audio and video element may be homogeneous throughout the flexible sheet audio-video device 14 or non-homogeneous. As such, certain areas of the flexible sheet audio-video device 14 may be devoid of particular audio and/or video elements. The various audio and video elements 10 and 12 may also be partially or completely segregated in the flexible sheet audio-video device 14. Such flexible/variable layouts/arrangements of the various audio and video elements are applicable to the various configurations of flexible sheet audio-video devices, although examples illustrated in this application typically show one arrangement for the purpose of clarity. Typically, the imaging elements 12 which form an image would be greater in number than the audio elements 10 in order to achieve greater resolution of the images sensed or displayed.

Each video imaging signal input element Vᵢ typically provides one pixel of the image displayed.

The audio elements are typically sized to be sufficiently small so as to not substantially interfere either with the video image display produced by the array of video image display elements or the video image captured by the array of video sensing elements. The audio elements may be sized on the order of an individual display pixel or smaller in order to achieve this.

The specifications and functionality of each individual audio and video element in a flexible sheet audio-video device may differ from the specifications and functionality of other audio and video elements in the same flexible sheet audio-video device. This enables varying operating characteristics for individual elements or groups of elements in order to fulfill the requirements of each particular application. For example, miniature speakers (or microphones) may have different frequency responses from other speakers (or microphones) in the same flexible sheet audio-video device. Similarly, video imaging display elements and video imaging sensing elements may have varying spectral characteristics compared to other video imaging display or sensing elements in the same flexible sheet audio-video device.

Each audio or video signal output or input element may occupy its own discrete position, or each position may contain various combinations of audio signal input and/or output elements, as well as video image signal input and/or output elements.

Audio and video-imaging functions are enabled by the single flexible sheet audio-video device 14 to reduce manufacturing costs, save space, increase reliability, reduce product assembly time, reduce both service time and the number of spare service parts in inventory, and enable a bendable/pliable configuration that accommodates both planar and non-planar as well as variable surfaces, spaces, areas, and shapes as well as to provide for a portable thin-profile low-weight compact one-piece design. The use of flexible sheet audio-video devices in planar configurations also provides advantages over the use of non-flexible audio-video flat panel devices in such configurations. Due to the bendable/pliable nature of flexible sheet audio-video devices, such devices are less prone to breakage, cracking, fracture, and malfunction resulting from physical shock caused by dropping, knocking against surfaces, or other physical insults as compared to their non-flexible counterparts. This flexible quality also enables the manufacture of devices that may be flexed or deformed for individualistic ergonomic requirements, for compactness and ease of transportation, and for applications where a flexible sheet audio-video device needs to be bent, deformed, or possibly rolled-up in order to first fit into an area whereby said sheet audio-video device subsequently attains its final desired shape. This is in sharp contrast to non-flexible substrate audio-video devices comprised of arrays of audio and video elements, as well as to current multi-component audio-visual systems that typically utilize a separate display device with an external microphone, external video capture device (i.e., “webcam”), and external speaker. Such configurations are bulky and space consuming, require wiring and setup/disassembly time, lack portability, and are not able to mount or conform or adjust to non-planar or variable/flexible contoured surfaces or areas.

Referring to FIG. 4, both audio signal input elements Aᵢ (i.e. speakers), and audio signal output elements Aₒ, (i.e. microphones), as well as video imaging signal output elements Vₒ (i.e. photosensors/cameras such as CMOS-MEMS photosensors) and video imaging signal input elements Vᵢ (i.e., display devices) may all be combined in a single flexible sheet audio-video device 16.

Audio signal output elements Aₒ such as MEMS-CMOS microphones are interspersed with audio signal input elements Aᵢ such as MEMS-CMOS speakers. Video imaging signal output elements Vₒ such as camera elements are also included on the same flexible sheet audio-video device 16. Lenses (not shown) may be utilized in conjunction with the video imaging elements Vₒ in order to generate acceptable images for a particular application.

Also included are video imaging signal input elements Vᵢ such as LCD's, LED's. The various arrayed elements Aₒ, Aᵢ, Vₒ and Vᵢ are depicted as being evenly interspersed throughout the flexible sheet audio-video device 16, but other distributions may be employed to achieve any desired particular purpose. The audio signal output array elements Aₒ each generate audio output signals which are read by an audio output signal reader 18. These signals would typically be processed in an audio output signal processor 20 used to operate a utilization (such as an external speaker) or memory device 22 for storing the audio signals. Such audio output signal processor 20 may use technology and algorithms known in the art to mix or otherwise produce signals with desired acoustical characteristics from signals obtained from audio signal output elements A₀.

The audio signal input array elements Aᵢ are connected to an audio input signal source 24 to drive the audio signal input elements such as the speakers described above to produce sound.

Similarly, the video imaging signal output array elements Vₒ, such as CMOS light sensors or CCDs, transmit their output signals to a video imaging output signal reader 26. A video imaging output signal processor 28 then prepares the signals prior to utilizing the signals in a utilization/memory device 30. Such video imaging output signal processor 28 may use technology and algorithms known in the art to assemble a final image from data obtained from the video imaging signal output array elements V₀.

A video imaging input signal source 32 is connected to the video imaging signal input elements Vᵢ (such as LCD's) to produce an image by the array elements Vᵢ.

The diagrammatic representations of various functional groups and their interrelationships, e.g., audio output signal reader 18, audio output signal processor 20, and utilization/memory device 22, are examples of some of the possible configurations of various flexible sheet audio-video device embodiments. Numerous other examples, variants, and configurations are possible and are apparent to those skilled in the art.

Thus, the single flexible sheet audio-video device 16 is capable of recording and displaying video imaging signals and broadcasting and recording audio signals, and may comprise a bi-directional audio-visual conference monitor device whereby two distantly located individuals may communicate with each other both visually and vocally by various communication means, such as the internet or radio waves, which are known in the art.

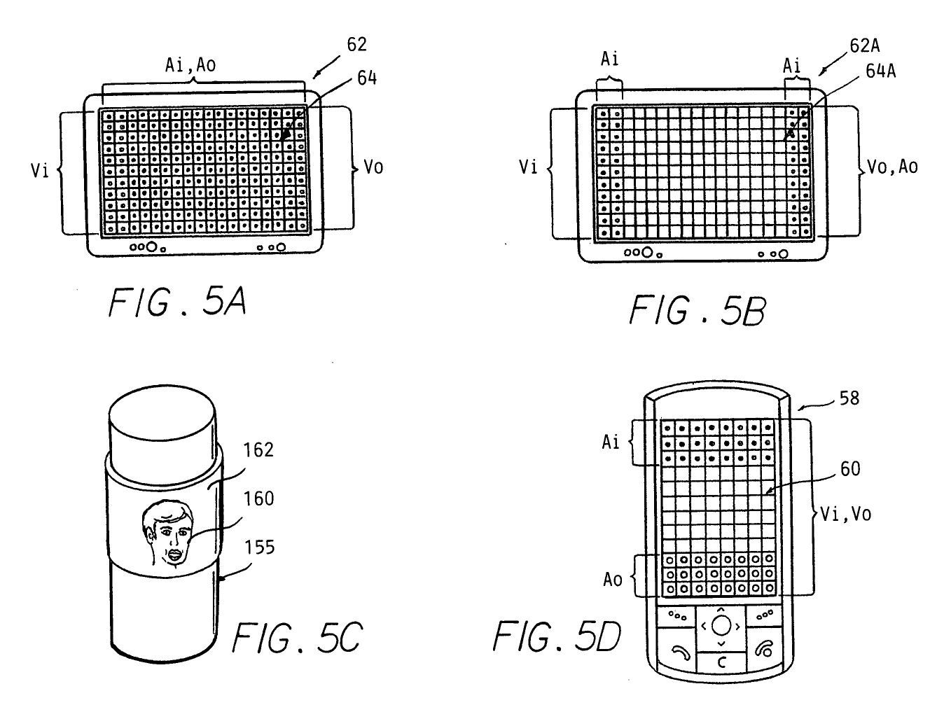

FIG. 5A illustrates a bendable/deformable conference monitor 62 in combination with a flexible sheet audio-video device 64 which is an embodiment of the above flexible sheet audio-video device 16. Audio signal input elements Aᵢ which may take the form of arrays of speakers, and video imaging signal input elements Vᵢ which may take the form of arrays of video display elements both may occupy the entire area of the flexible sheet audio-video device 64 or portions thereof. Arrays of video imaging signal output elements Vₒ which add image capture, i.e., camera, functionality, and arrays of audio signal output elements Aₒ such as MEMs microphones which enable the capture of sounds directed towards monitor 62, may also be included distributed across the entire flexible sheet audio-video device 64 or portions thereof. Thus, audio-visual sensing and reproducing functions are provided by a single device, whereby audio/visual elements Aₒ. Aᵢ, Vₒ and Vᵢ may be distributed in a variety of positions, proportions, and distributions in order to fulfill the requirements of a particular application. The detailed connectivity of the flexible sheet audio-video device 64 to audio-visual input signal sources and output signal readers is not detailed as such assembly is known to those skilled in the art.

FIG. 5B shows another embodiment of flexible sheet audio-video device 64 in which a flexible sheet audio-video device 64A is combined with a bendable conference monitor 62A whereby flexible sheet audio-video device 64A is comprised of arrays of elements as in flexible sheet audio-video device 64, except that audio signal input elements Aᵢ here may take the form of arrays of speakers occupying regions on both sides of the flexible sheet audio-video device 64A.

The bendable/pliable nature of flexible sheet audio-video device 16 in the embodiment of flexible sheet audio-video device 64 incorporated in flexible conference monitor 62 (FIG. 5A) enables monitor 62 to be mounted flush against a flat surface (not shown) or to be conformed to 3-dimentional areas or surfaces such as a non-planar vertical cylindrical building support or kiosk 155 (FIG. 5C) whereby monitor 62 in the embodiment of flexible conference monitor 162 is wrapped around kiosk 155 and displays image 160. Audio-visual interaction with monitor 162 may thus be conducted freely at various positions around kiosk 155 instead of requiring a user to remain in a fixed position. Video manipulation software may be employed such as in the video imaging output signal processor 28 (FIG. 4) to reduce or eliminate image distortions which may result from non-planar conformations of the monitor 162. Similarly, suitable software may enable the tracking of each user's movements around kiosk 155 for display on the remote conferencing monitor. Such imaging software is known to those skilled in the art. Monitor 62 may also be draped over surfaces or areas such as over the edge of a table (not shown) to provide for a temporary location for a conferencing monitor used at an impromptu sales presentation at a worksite.

Another example of the use of flexible sheet audio-video device 16 is in the combination of a flexible sheet audio-video device 60 with a portable communication device such as a cell/mobile phone. FIG. 5D illustrates an embodiment comprising a cell phone 58 combined with a flexible sheet audio-video device 60 which has an upper region including an array of audio signal input elements Aᵢ in the form of speakers. The entire flexible sheet audio-video device 60 includes video imaging signal input elements Vᵢ arrayed therein to provide a visual display, and also may include video imaging signal output elements Vₒ arrayed therein to provide a camera imaging function.

The bottom region of flexible sheet audio-video device 60 has audio signal output elements A₀ arrayed therein in the form of miniature microphones. Thus, the flexible sheet audio-video device 60 may provide both audio and video functions. The flexible sheet audio-video device 60 may also have some or all of the above described audio and video elements dispersed throughout the entire flexible sheet audio-video device 60 area.

It should be appreciated that the flexible sheet audio-video device 60 according to the invention doesn't necessarily require that the various audio and video elements be interspersed throughout the entire array area, but some regions may have some elements segregated or dispersed only therein.

Note that the above described flexible sheet audio-video device 60 of arrayed audio and video elements replaces the dedicated display, microphone, speaker, and camera assemblies commonly found in mobile communication devices, thus freeing up the valuable limited space often dedicated both above and below the display screen used to accommodate these separate assemblies. By replacing these independent component assemblies with the one-piece flexible sheet audio-video device 60 of this invention, the size/area of the display screen may thus be enlarged by utilizing the space previously utilized by the microphone, speaker, and camera assemblies. This enlarged display area is thus accomplished without enlarging the physical size of the cell phone.

Due to the bendable/pliable nature of the flexible sheet audio-video device 60, the flexible sheet audio-video device 60 in the illustrated planar configuration is less prone to breakage and malfunction resulting from physical shock caused by dropping, knocking against surfaces, or other physical insults as compared to a non-flexible planar audio-video panel device which may be constructed of rigid or stiff materials that may easily crack and fracture.

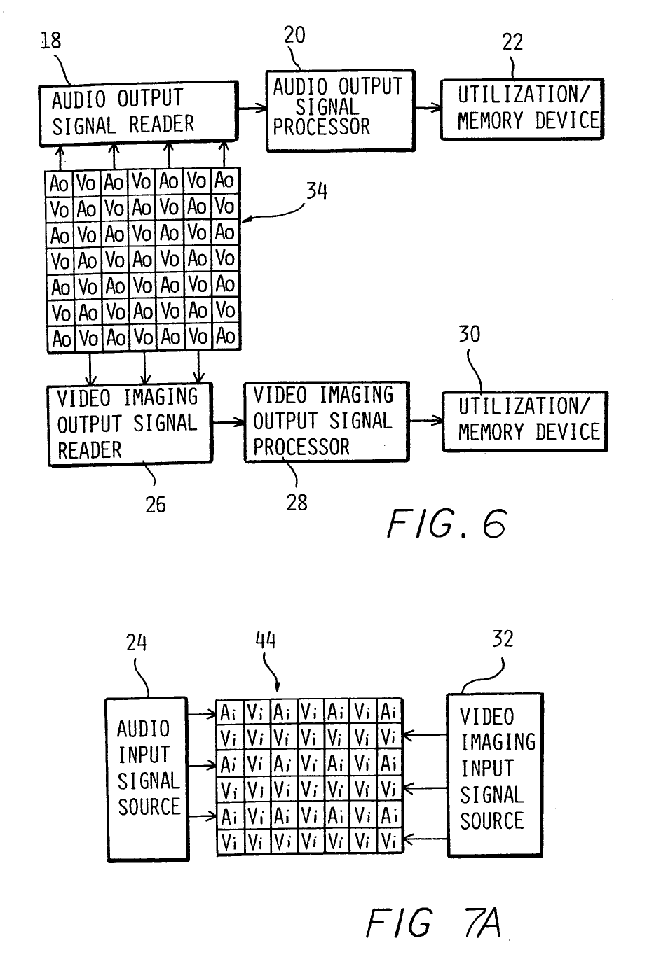

FIG. 6 shows a flexible sheet audio-video device 34 comprised of arrays of both audio signal output elements Aₒ and video imaging signal output elements Vₒ. The audio signal output elements Aₒ are connected as before to an audio output signal reader 18. These signals may then be processed in an audio output signal processor 20 and then sent to a utilization/memory device 22.

Similarly, the video imaging signal output elements Vₒ, such as CMOS photosensitive camera elements, CCDs, or photosensors, transmit their output signals to a video imaging output signal reader 26. A video imaging output signal processor 28 then prepares the signals prior to utilizing the signals in a utilization/memory device 30. This flexible sheet audio-video device 34 could be used as a video-audio recorder wrapped around a cylindrical kiosk 155 such as illustrated in FIG. 5C and used as a surveillance device to obtain sound and images with complete 360 degree coverage of an area of interest. Such efficacy is not practical or feasible using existing technology.

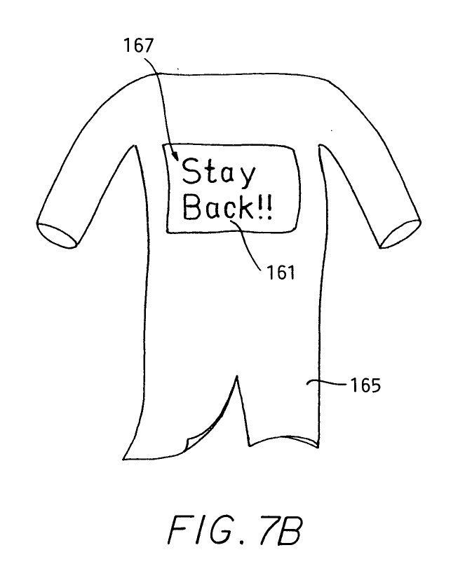

FIG. 7A depicts a flexible sheet audio-video device 44 wherein an array of audio signal input elements Aᵢ is combined with an array of video imaging signal input elements Vᵢ.

In this flexible sheet audio-video device 44, an audio input signal source 24 is connected to audio signal input elements Aᵢ, such as the CMOS MEMS speakers referred to above, and a video imaging input signal source 32 is connected to video imaging signal input elements Vᵢ, such as LCD's. Thus a single device 44 can provide both sound and video playback such as in a television, computer monitor, credit card, smart cards, control panel, entertainment/game display, presentation devices (i.e., movie screen replacement), portable map devices (whereby a user may view map or architectural drawing details while listening to audio directions/descriptions), newspaper viewing devices, reading devices (such as the www.Amazon.com portable “Kindle”), e-paper, electronic paper, digital paper, wristwatches, portable communication devices, intelligent medical bandages, RFID tags, cardboard boxes, curtains, body ornaments/jewelry, furniture.

FIG. 7B illustrates an example of a flexible sheet audio-video device 44 in the embodiment of flexible sheet audio-video device 161 attached to or comprising an article of clothing such as a shirt, pants, hat, shoes, or jacket 165, wherein the device 161 displays an image 167 while broadcasting an audible message. Flexible sheet audio-video device 161 varies its 3-dimensional contour in relation to the variable contour of the underlying non-planar surface (body or undergarment) and thus device 161 does not impede the wearer from bending, twisting, or freely moving; whereas, a non-flexible rigid audio-video panel device display would not provide the wearer with the necessary freedom of motion. In this example, a flexible sheet audio-video device 161 positioned on an emergency worker's coat 165 both audibly and visually warns pedestrians to “Stay Back!!”, thus freeing the worker's time to handle an emergency situation. The detailed connectivity of the flexible sheet audio-video device 161 to audio-visual input signal sources is not detailed as such assembly is known to those skilled in the art.

A method of fabricating flexible sheet audio-video devices of the present invention in the form of clothing or fabrics is exemplified by the above referenced article “Intelligent Textiles” by Yong Xu.

A flexible sheet audio-video device 161 may also be wrapped around the full circumference of a kiosk structure 155 (FIG. 5C) to provide audio-visual advertisements 160 to pedestrians who may approach the kiosk 155 from any direction.

Flexible sheet audio-video devices of this invention may also be utilized to create either customized one-of-a-kind, or mass produced identical audio-visual based “smart” control panels for countless applications such as a non-planar automobile wrap-around instrument panel, whereby such panels may be configured virtually instantaneously (i.e. “on-the-fly”) by a suitable programming interfaced controller as known by those skilled in the art.

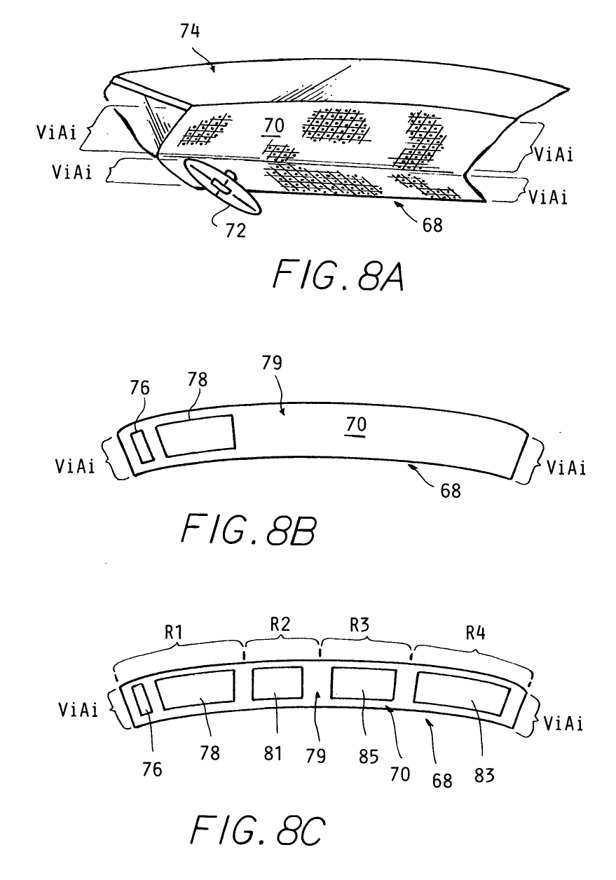

FIG. 8A illustrates a non-planar wrap-around automobile instrument panel 68 including a flexible sheet audio-video device 70 of the present invention applied to a rigid substrate (not shown) to be in conformity with the contours thereof which has arrays of both video imaging signal input display elements Vᵢ and audio signal input speaker elements Aᵢ (not drawn to scale); both elements depicted as being evenly dispersed throughout panel 70. A steering wheel 72, and windshield 74 are also shown.

FIG. 8B utilizes the flexible sheet audio-video device 70 depicted in FIG. 8A, and depicts audio-visual display gauge portion 76 whose arrayed video imaging signal input elements Vᵢ displays automobile operating status parameters such as engine temperature while arrayed audio signal input elements Aᵢ output audible warning messages for aberrant operating conditions or audio from the car radio (not shown). Similarly, the arrayed audio-video elements Aᵢ Vᵢ enable audio-visual display 78 to provide a visual digital speedometer while producing audible messages for excessive speed or audio from the car radio. Arrayed video imaging signal input display elements Vᵢ and arrayed audio signal input speaker elements Aᵢ that are not utilized by display areas 76 or 78 may display colors and patterns throughout the remainder of the instrument panel area 79 to match the decor of the car interior and broadcast audio from the car radio.

Altering the just described instrument panel 68 layout to accommodate the addition, deletion, or modification of the shape or position of audio-visual displays such as displays 76, 78 is easy and can be accomplished within seconds.

Referring to FIG. 8C, the addition of both an audio-visual display 81 utilized by a GPS (global positioning satellite) navigational system (not shown) and an audio-visual display 83 utilized by a front seat passenger television (not shown) to the instrument panel 68 depicted in FIG. 8B is simple since the arrays of both video display elements Vᵢ and audio speaker elements Aᵢ that are utilized by these additional devices are already built into and thus inherent to flexible sheet audio-video device 70. GPS and television audio-visual signals are interfaced to the arrays of audio and video elements, Aᵢ and Vᵢ, respectively, by a suitable programmable controller known to those skilled in the art, thus enabling the activation and usage of audio-visual displays 81 and 83.

The positions (within panel 70), shape, and dimensions of audio-visual displays 76, 78, 81, and 83 are arbitrary throughout flexible sheet audio-video device 70 and may be specified at the automobile factory or even by each automobile driver by perhaps a user friendly “pop-up” audio-visual “set-up” display 85 that allows the driver to select the layout of the instrument panel so that it best meets the ergonomic needs of that particular driver and passengers. The driver may interact with pop-up display 85 by touch sensor elements (not shown) which are embedded in panel 70 and are known in the art, or by other means (i.e. keyboard, not shown).

The driver thus interacts via display 85 with a suitable controller that associates the specific audio-visual signals of external devices (i.e. GPS, car radio) with specific audio-visual array elements Aᵢ, Vᵢ within the flexible sheet audio-video device 70 to meet both the functional and esthetic needs of the driver and passengers.

This example shows the immense adaptability of flexible sheet audio-video devices in that they can accommodate the specific requirements of a virtually endless variety of audio-visual based features and functions and layouts for applications ranging from automobile “smart” instrument panels to any other type of audio-visual based control panel.

Referring again to FIG. 8C, arrayed audio signal input speaker elements Aᵢ may be treated as various arbitrary regions such as R1, R2, R3, and R4 whereby the regions R1, R2, and R3 may direct GPS audible directions to the driver, while region R4 directs television audible sound towards the front seat passenger. A stereo effect may be achieved by two separate audio signals transmitted to regions R1, R2 and R3, R4. The detailed connectivity of the flexible sheet audio-video device 70 to audio-visual input signal sources is not detailed as such assembly is known to those skilled in the art.

Thus, flexible sheet audio-video device 70 provides for a limitless number of easily customizable audio-video display configurations without the need to make physical changes to the instrument panel. Such capabilities are not currently possible with existing technology.

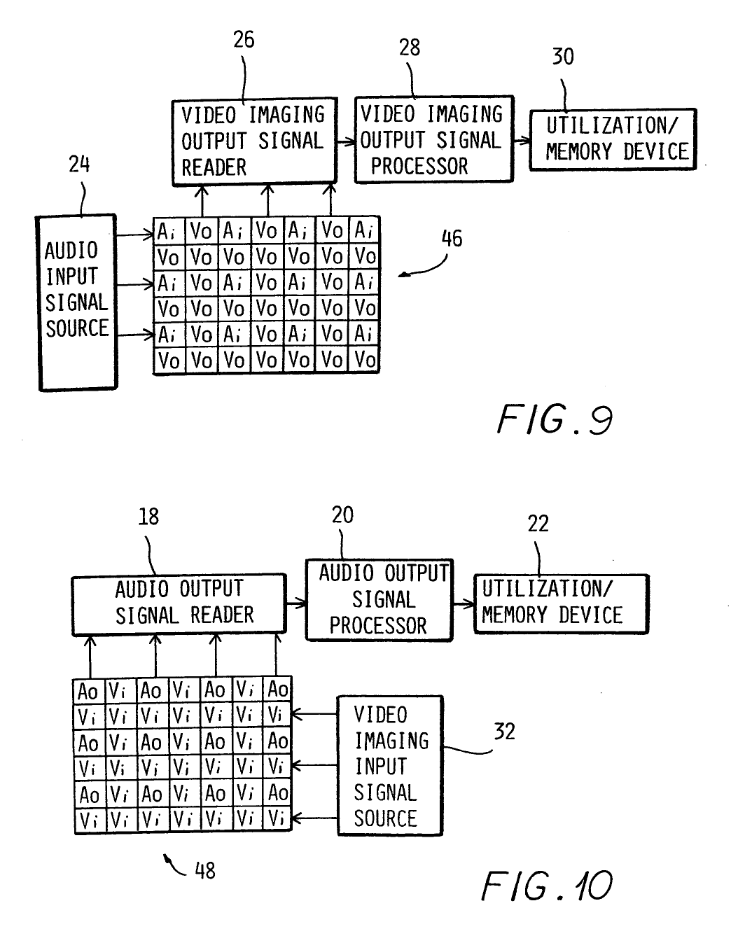

FIG. 9 illustrates flexible sheet audio-video device 46 which incorporates audio signal input speaker array elements Aᵢ, connected to an audio input signal source 24. The flexible sheet audio-video device 46 also includes interspersed video imaging signal output photo sensing array elements Vₒ connected to a video imaging output signal reader 26, which in turn is connected to video imaging output signal processor 28, which is connected to a utilization/memory device 30.

This device allows an audio message to be broadcast, as for example audio instructions or prompts, to aid in camera use while video images are being recorded, and may also be employed in other applications.

FIG. 10 shows another embodiment in the form of flexible sheet audio-video device 48 which includes audio signal output microphone array elements Aₒ interspersed with video imaging signal input display array elements Vᵢ.

An audio output signal reader 18 is connected to the audio signal output elements Aₒ whereby the audio output signal reader 18 is then connected to audio output signal processor 20 which in turn is connected to a memory/utilization device 22.

A video imaging input signal source 32 is connected to the video imaging signal input array elements Vᵢ to generate a display by the array 48. This device would be useful to provide visual prompting while recording an audio signal in utilization/memory device 22, and may also be used in other applications.

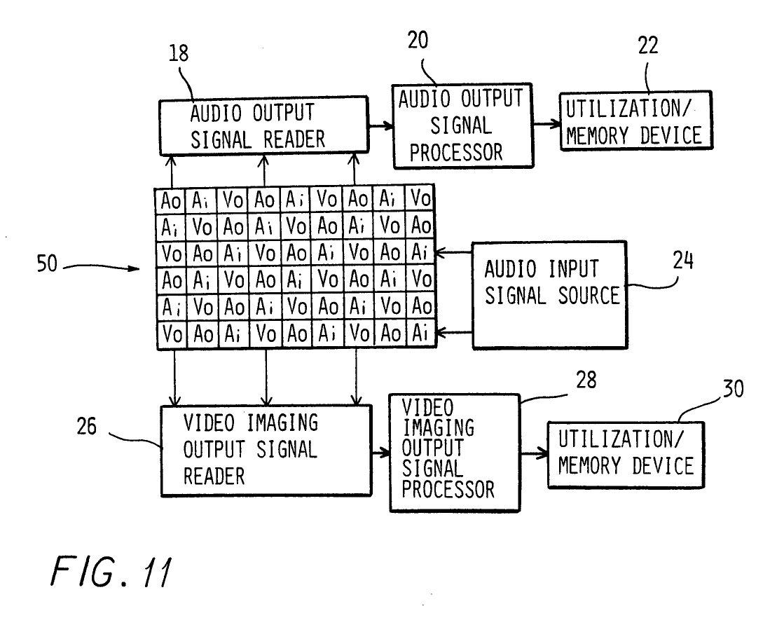

FIGS. 11-14 illustrate some other possible combinations of audio and video array elements that may be combined in a flexible sheet audio-video device.

FIG. 11 shows a flexible sheet audio-video device 50 in which both audio signal input speaker and output microphone array elements Aᵢ, Aₒ are combined with video imaging signal output photo sensing array elements Vₒ. The audio signal input speaker elements Aᵢ are connected to an audio input signal source 24, while the audio signal output microphone elements A₀ are connected to an audio output signal reader 18, then connected to an audio output signal processor 20, and then connected to a utilization/memory device 22.

The video imaging signal output camera elements Vₒ are connected to a video imaging output signal reader 26, in turn connected to a video imaging output signal processor 28 and then utilization/memory device 30. This device would be useful in video monitoring applications such as where audible 2-way communications between medical personnel and a patient can take place while the medical personnel can concurrently view the patient. In this application, there is no need for the patient to view the medical staff. Other applications for this device are also applicable.

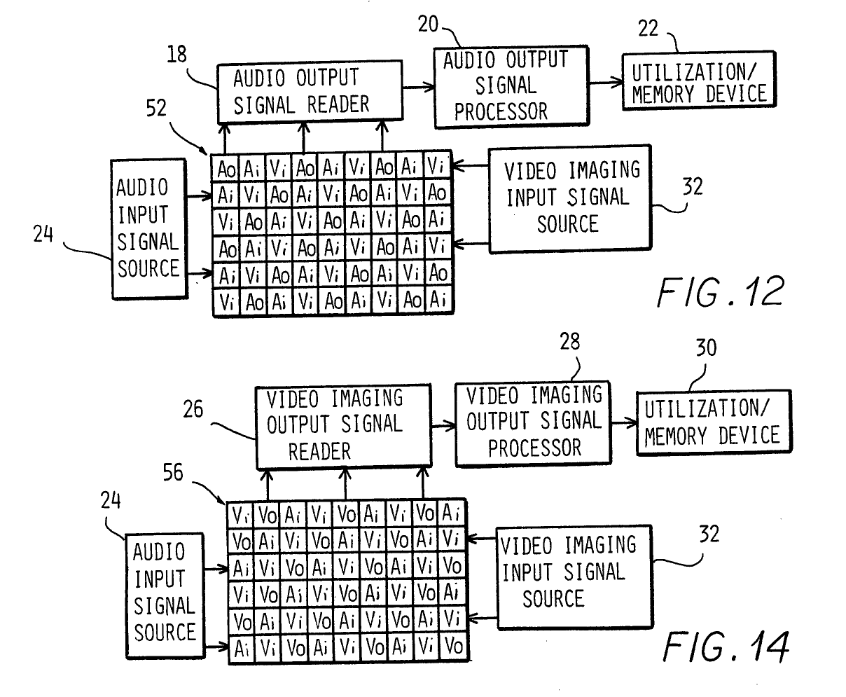

The FIG. 12 depicted flexible sheet audio-video device 52 combines both audio signal input speaker and output microphone arrayed elements Aᵢ, Aₒ, with arrayed video imaging signal input display Vᵢ elements. The audio signal input elements Aᵢ are connected to an audio input signal source 24, and the audio signal output elements Aₒ are connected to an audio output signal reader 18, in turn connected to an audio output signal processor 20 and then utilization or memory device 22.

The video imaging signal input elements Vᵢ are connected to a video imaging input signal source 32. Such a device could combine a visual display with an audio recorder with a playback capability, such as in a display monitor with bi-directional audio capability which may be employed by a security firm which visually monitors a remote area and requires bi-directional voice communications with security personnel at said remote area. This device may also be employed in other applications.

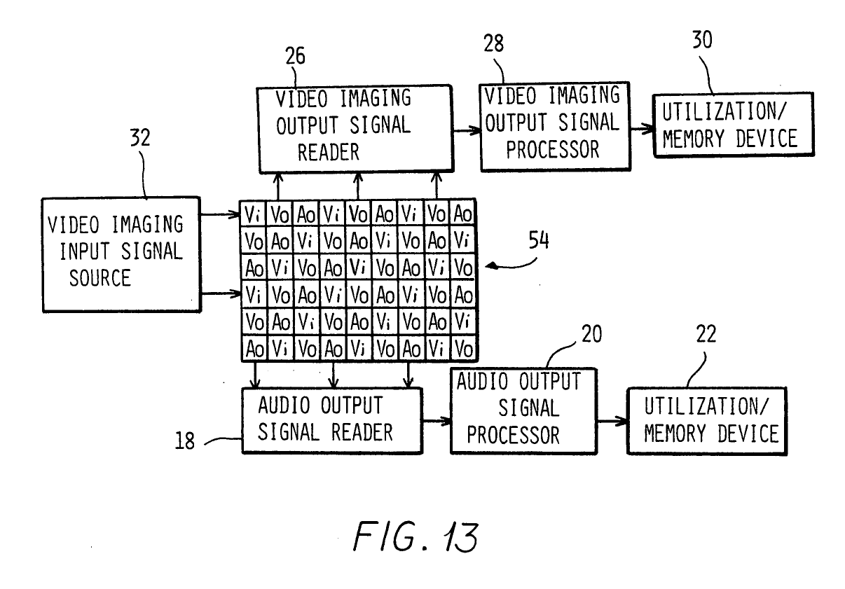

FIG. 13 shows a flexible sheet audio-video device 54 combining both video imaging signal input display and output image capture arrayed elements Vᵢ and Vₒ with arrayed audio signal output microphone elements Aₒ. The video image signal input elements Vᵢ, such as LCD's are connected to a video imaging input signal source 32.

The video imaging signal output elements Vₒ, are connected to a video imaging output signal reader 26 in turn connected to a video imaging output signal processor 28 and then utilization/memory device 30. Audio signal output elements Aₒ are connected to an audio output signal reader 18, in turn connected to an audio output signal processor 20 and then utilization or memory device 22. Such a device 54 could be used in a video recorder/display device with audio recording capability. An example of an application of this device 54 is in an instructor's conferencing monitor used in remote teaching environments where an instructor's image is captured for presentation to a room of remotely located students, while a video image of the students is presented to the instructor, as the instructor provides verbal lessons to said students by the instructor's voice being captured by audio signal output elements Aₒ. This device may also be utilized in other applications.

FIG. 14 shows a flexible sheet audio-video device 56 which includes both video imaging signal input display and output photo-sensing arrayed elements Vᵢ, Vₒ combined with audio signal input speaker arrayed elements Aᵢ.

The video imaging signal input elements Vᵢ, are connected to a video imaging input signal source 32. The video imaging signal output elements Vₒ are connected to a video imaging output signal reader 26, in turn connected to a video imaging output signal processor 28, which in turn is connected to a utilization or memory device 30. The audio signal input elements Aᵢ are connected to an audio input signal source 24. Such flexible sheet audio-video device 56 could be used as a video recorder and display device having audio promptings during video recording, as well as in other applications such as a replacement for flexible sheet audio-video device 70 in the automobile control panel (instrument panel) of FIG. 8C. Camera elements Vₒ along with suitable image processing software known in the art in the video imaging signal processor 28 can determine if the front passenger seat is vacated, whereby the passenger television audio-visual display 83 may instantaneously disappear (along with the associated sound and television images being displayed) and be replaced with a display of perhaps the colors and patterns that are filling the rest of area 79 along with sound from the car radio (not shown).

The flexible sheet audio-video devices of this invention may also incorporate touch sensing technology that is known in the art to enable further interaction between said flexible sheets and the user whereby coordinate positions as well as qualities such as the degree of finger pressure may be sensed and utilized by suitable software.

Individual audio elements that may perform both audio sensing and audio broadcasting functions, and individual video elements that may perform both video optical sensing and video displaying functions could be employed in flexible sheet audio-video devices in order to reduce the number of different audio-visual element types.

What is claimed is:

1. An audio-video device comprising:
an array of audio elements carried by a flexible sheet including said audio-video device, each of said audio elements comprising a sound reproducing audio element capable of reproducing sound when receiving audio signals from an audio signal source and/or comprising a sound sensing audio element capable of sensing sound and producing output signals corresponding to said sensed sound;
an array of video elements also carried by said flexible sheet at least partially interspersed with said array of audio elements, each video element comprising a display forming video element able to form a pixel of an image when excited by video input signals received from a source and/or comprising an image sensing video element able to produce output signals corresponding to an image sensed by said array of imaging sensing video elements, said audio elements being small enough to not substantially interfere with images formed or sensed by said video elements;
whereby both audio and video functions are provided by said audio-video device.

2. The audio-video device according to claim 1 wherein said video elements include display forming video elements.

3. The audio-video device according to claim 1, wherein said array of audio elements includes both reproducing and sensing audio elements.

4. The audio-video device according to claim 3 wherein said array of video elements includes both display forming and image sensing video element.

5. The audio-video device according to claim 1 wherein said sound reproducing audio elements comprise CMOS MEMS speakers.

6. The audio-video device according to claim 4 in combination with a cellular telephone.

7. The audio-video device according to claim 4 in combination with a television.

8. The audio-video device according to claim 1 in combination with a computer monitor.

9. The audio-video device according to claim 1 wherein said audio elements comprise CMOS-MEMS speakers or CMOS-MEMS microphones.

10. The audio-video device according to claim 2 wherein said video display forming elements comprise LCD's.

11. The audio-video device according to claim 4 wherein said image sensing video elements comprise CCD light sensors.

12. The audio-video device according to claim 4 wherein said image sensing video elements comprise CMOS light sensors.

13. The audio-video device according to claim 1 wherein said array of audio elements is substantially completely interspersed with said array of video elements.

14. The audio-video device according to claim 1 wherein at least some of said audio and/or video elements are segregated together on said flexible sheet.

15. The audio-video device according to claim 1 wherein said video elements and said audio elements are distributed homogeneously over said flexible sheet.

16. The audio-video device according to claim 1 in combination with an article of clothing.

17. The audio-video device according to claim 1 wherein said flexible sheet is conformed to at least a portion of an automotive instrument panel in combination with said audio-video device.

18. The audio-video device according to claim 17 wherein a region of said flexible sheet has video elements displaying engine gauge information.

19. The audio-video device according to claim 18 wherein said display forming video elements display other images in another region.

20. The audio-video device according to claim 19 wherein a radio receiver audio ouput is reproduced by said sound reproducing audio elements.

21. The audio-video device according to claim 4 in combination with a conferencing monitor.

22. The audio-video device according to claim 1 including only sound reproducing audio elements and only image forming video elements.
